(19) United States
(12) Patent Application Publication
(10) Pub. No.: US 2014/0356624 A1
(43) Pub. Date: Dec. 4, 2014

(54) SILICA COMPOSITE PARTICLES AND METHOD OF PRODUCING THE SAME

(71) Applicant: FUJI XEROX CO., LTD., Tokyo (JP)

(72) Inventors: Chika HAMA, Kanagawa (JP); Yoshifumi IIDA, Kanagawa (JP); Hiroyoshi OKUNO, Kanagawa (JP)

(73) Assignee: FUJI XEROX CO., LTD., Tokyo (JP)

(21) Appl. No.: 14/059,933

(22) Filed: Oct. 22, 2013

(30) Foreign Application Priority Data
Jun. 3, 2013 (JP) 2013-117177

(51) Int. Cl. C09C 1/30

(52) U.S. Cl. CPC C09C 1/3063
USPC 428/402; 556/173

(57) ABSTRACT

Disclosed are silica composite particles in which silica particles are subjected to surface treatment with an aluminum compound in which an organic group is bonded to an aluminum atom through an oxygen atom, and an aluminum surface coverage is from 0.01 atomic % to 30 atomic %, an average particle size is from 30 nm to 500 nm, and a particle size distribution index is from 1.1 to 1.5.

### CROSS-REFERENCE TO RELATED APPLICATIONS

This application is based on and claims priority under 35 USC 119 from Japanese Patent Application No. 2013-117177 filed Jun. 3, 2013.

### BACKGROUND

1. Technical Field

The present invention relates to silica composite particles and a method of producing the same.

2. Related Art

Silica particles are used as additives or main components of toners, cosmetics, rubbers, abrasives and the like, and have a role of, for example, improving the strength of resin, improving the fluidity of powder, or preventing packing. Since it is considered that the properties of silica particles are likely to depend on the shape and surface properties of those silica particles, surface treatment of silica particles and complexation of silica and metal or a metal compound have been proposed.

### SUMMARY

According to an aspect of the invention, there are provided silica composite particles in which silica particles are subjected to surface treatment with an aluminum compound in which an organic group is bonded to an aluminum atom through an oxygen atom, and an aluminum surface coverage is from 0.01 atomic % to 30 atomic %, an average particle size is from 30 nm to 500 nm, and a particle size distribution index is from 1.1 to 1.5.

### DETAILED DESCRIPTION

Hereinafter, an exemplary embodiment showing an example of the present invention will be described in detail.

Silica Composite Particles

The silica composite particles according to the exemplary embodiment are silica composite particles in which silica particles are subjected to surface treatment with an aluminum compound in which an organic group is bonded to an aluminum atom through an oxygen atom.

The silica composite particles according to the exemplary embodiment have an aluminum surface coverage of from 0.01 atomic % to 30 atomic %, an average particle size of from 30 nm to 500 nm, and particle size distribution index of from 1.1 to 1.5.

In the silica composite particles, the surface covered by aluminum with the above coverage forms the outermost surface.

The silica composite particles according to the exemplary embodiment may be silica composite particles in which silica particles are subjected to surface treatment with an aluminum compound and further subjected to surface treatment with a hydrophobizing agent. Even in this case, the aluminum surface coverage of the silica composite particles is from 0.01 atomic % to 30 atomic %, the average particle size is from 30 nm to 500 nm, and the particle size distribution index is from 1.1 to 1.5.

In the silica composite particles, the surface covered by aluminum with the aforementioned coverage forms the outermost surface which is subjected to hydrophobization treatment.

Due to the aforementioned configuration, the silica composite particles according to the exemplary embodiment are excellent in dispersibility into a target to be attached (for example, resin particles, iron powder, and other powders) and are less likely to disturb the fluidity of the target to be attached. The reason for this is not clear, but is considered to be as follows.

Silica composite particles having the aforementioned average particle size and the aforementioned particle size distribution index have an appropriate size within a narrow particle size distribution. Since such silica composite particles have a narrow particle size distribution in an appropriate size, the adhesion among the particles is considered to be lower than in a particle group with a wide particle size distribution and thus less likely to cause friction among the particles. As a result, it is considered that the silica composite particles themselves are excellent in fluidity.

Due to the aforementioned mechanism, first, from the viewpoint of the particle shape, it is considered that the silica composite particles according to the exemplary embodiment are excellent in dispersibility into a target to be attached and are less likely to disturb the fluidity of the target to be attached.

In addition, since at least a part of the surface of the silica composite particles according to the exemplary embodiment is covered with aluminum, static electricity is more likely to be released as compared with the silica particles including only silicon oxide. As a result, it is considered that the particles are less likely to aggregate. Therefore, it is considered that the silica composite particles according to the exemplary embodiment are excellent in dispersibility into a target to be attached and are less likely to disturb the fluidity of the target to be attached.

As described above, it is considered that the silica composite particles according to the exemplary embodiment are excellent in dispersibility into a target to be attached and are less likely to disturb the fluidity of the target to be attached due to synergistic effect of particle shape and aluminum surface coverage.

Further, it is preferable that the average circularity of the silica composite particles according to the exemplary embodiment is within a range of from 0.5 to 0.85, that is, it is preferable that the silica composite particles have an irregular shape having more unevenness as compared with a real sphere. When the particles have an irregular shape with an average circularity of 0.85 or less, it is considered that in a case of being attached to a target to be attached, uneven distribution or deviation caused by embedding into the target to be attached or rolling is less likely to occur as compared with a case of a spherical shape (a shape having an average circularity of greater than 0.85). It is considered that destruction caused by a mechanical load is less likely to occur in the silica composite particles as compared with a case of a shape with an average circularity of less than 0.5.

Due to the aforementioned mechanism, when the average circularity of the silica composite particles according to the exemplary embodiment is within the aforementioned range, it is considered that dispersibility into a target to be attached is more excellent and that the fluidity of the target to be attached is less likely to be disturbed.

When the silica composite particles according to the exemplary embodiment are not subjected to surface treatment with a hydrophobizing agent, dispersibility into an aqueous medium is excellent. This is because it is considered that since the aluminum surface coverage is within the aforementioned range, that is, at least a part of the surface is covered with aluminum, water is likely to be retained and affinity with water is excellent.

Hereinafter, the silica composite particles according to the exemplary embodiment will be described in detail.

Aluminum Coverage

The silica composite particles according to the exemplary embodiment are composite particles formed of silicon oxide (silicon dioxide, silica), in which the surface is subjected to surface treatment with an aluminum compound, that is, composite particles in which more aluminum is present on the surface layer as compared with the inner part of the silica particles.

The aluminum surface coverage of the silica composite particles is from 0.01 atomic % to 30 atomic %.

When the aluminum coverage is less than 0.01 atomic %, erasing effect in which static electricity is released is less likely to be obtained and thus the silica composite particles aggregate in some cases.

On the other hand, when the aluminum coverage is greater than 30 atomic %, during the surface treatment of the silica particles with an aluminum compound, excessive coarse powder, extension of particle size distribution, or excessive irregularity of the shape is likely to occur due to a vigorous reaction of the aluminum compound. When a mechanical load is applied, the silica composite particles are likely to have defects and become a factor of disturbing the fluidity of a target to be attached.

For the aforementioned reasons, the aluminum surface coverage of the silica composite particles is preferably from 0.05 atomic % to 20 atomic % and more preferably from 0.1 atomic % to 10 atomic %.

Even when the silica particles of the silica composite particles according to the exemplary embodiment are subjected to surface treatment with an aluminum compound and further subjected to surface treatment with a hydrophobizing agent, for the aforementioned reasons, the aluminum coverage of the surface is from 0.01 atomic % to 30 atomic %, preferably from 0.05 atomic % to 20 atomic %, and more preferably from 0.1 atomic % to 10 atomic %.

The aluminum surface coverage (atomic %) of the silica composite particles is obtained using the following method. Using a scanning type X-ray fluorescence spectrometer (ZSX Primus II, manufactured by Rigaku Corporation), a disk having a particle weight of 0.130 g is molded and qualitative and quantitative analysis of all elements is performed under the conditions of an X-ray output of 40 kV-70 mA, a measurement area of 10 mmφ, and a measurement time of 15 minutes, to set an analysis value of EuLφ and BiLφ of the obtained data as an element amount of the exemplary embodiment. The ratio of the number of aluminum atoms accounting for a total number of atoms forming the surface of the silica composite particles (100×number of aluminum atoms/total number of atoms) (atomic %) is obtained.

Average Particle Size

The silica composite particles according to the exemplary embodiment have an average particle size of from 30 nm to 500 nm.

When the average particle size of the silica composite particles is less than 30 nm, the shape of the silica composite particles tends to be spherical (a shape having an average circularity of greater than 0.85), and it is difficult to have a shape having an average circularity of the silica composite particles from 0.5 to 0.85. In addition, when the average particle size is less than 30 nm, even in a case where the silica composite particles have an irregular shape, it is difficult to prevent the embedding of the silica composite particles into a target to be attached and fluidity of a target to be attached is likely to be disturbed.

On the other hand, when the average particle size of the silica composite particles is greater than 500 nm, in a case where a mechanical load is applied to the silica composite particles, the particles are likely to have defects, which makes it easy to disturb the fluidity of a target to be attached.

For the aforementioned reasons, the average particle size of the silica composite particles is preferably from 60 nm to 500 nm, more preferably from 100 nm to 350 nm, and even more preferably from 100 nm to 250 nm.

The average particle size of the silica composite particles is the average particle size of the primary particles. Specifically, when the silica composite particles are dispersed into resin particles having a particle size of 100 μm (polyester, weight average molecular weight Mw=50,000), 100 primary particles of the dispersed silica composite particles are observed with a scanning electron microscope (SEM). The respective circle-equivalent diameters of 100 primary particles are obtained by the image analysis and a circle-equivalent diameter at a number accumulation of 50% (50th) in the number-based distribution from a small diameter side is defined as an average particle size.

Particle Size Distribution Index

The silica composite particles according to the exemplary embodiment have a particle size distribution index of from 1.1 to 1.5.

The silica composite particles in which the particle size distribution index of the silica composite particles is less than 1.1 are difficult to be produced.

On the other hand, when the particle size distribution index of the silica composite particles is greater than 1.5, coarse particles occur, or the dispersibility into a target to be attached deteriorates due to variations in particle size. In addition, with the increase of the presence of the coarse particles, number of defects in the particles increases due to mechanical loads thereof, and thus, fluidity of a target to be attached is likely to be disturbed.

For the aforementioned reasons, the particle size distribution index of the silica composite particles is preferably from 1.25 to 1.4.

The particle size distribution index of silica composite particles is the particle size distribution index of the primary particles. Specifically, when the silica composite particles are dispersed into resin particles having a particle size of 100 μm (polyester, weight average molecular weight Mw=50,000), 100 primary particles of the dispersed silica composite particles are observed with an SEM. The respective circle-equivalent diameters of 100 primary particles are obtained by the image analysis and a square root of the value obtained by dividing a circle-equivalent diameter at a number accumulation of 84% (84th) in the number-based distribution from a small diameter side, by a circle-equivalent diameter at a number accumulation of 16% (16th) obtained in the same manner is defined as a particle size distribution index.

Average Circularity

It is preferable that silica composite particles according to the exemplary embodiment have an average circularity of from 0.5 to 0.85.

When the average circularity of the silica composite particles is 0.5 or greater, a vertical/horizontal ratio of the silica composite particles is not too large. Thus, in a case where a mechanical load is applied to the silica composite particles, stress concentration is less likely to occur, and thereby the particles do not tend to have defects and are less likely to be a factor in disturbing fluidity of a target to be attached.

On the other hand, when the average circularity of the silica composite particles is 0.85 or less, the shape of the silica composite particles is irregular. Thus, the silica composite particles are less likely to be unevenly attached to a target to be attached and are less likely to be detached from the target to be attached.

For the aforementioned reasons, the average circularity of the silica composite particles is preferably from 0.6 to 0.8.

The average circularity of the silica composite particles is the average circularity of the primary particles. Specifically, when the silica composite particles are dispersed into resin particles having a particle size of 100 μm (polyester, weight average molecular weight Mw=50,000), 100 primary particles of the dispersed silica particles are observed with an SEM. The respective periphery lengths (I) and projected areas (A) of 100 primary particles are obtained by the image analysis and the respective degrees of circularity of 100 primary particles are calculated by a formula “4π×(A/I²)”. Then, a circularity at a number accumulation of 50% (50th) in the number-based distribution of 100 primary particles from a small diameter side is defined as an average circularity.

The image analysis for obtaining the circle-equivalent diameters, periphery lengths and projected areas of 100 primary particles, is performed, for example, in the following method. 2D images are captured at 10,000-fold magnification using an analyzer (ERA-8900, manufactured by ELIONIX INC.) and the periphery lengths and projected areas are obtained under the condition of 0.010000 μm/pixel, using a piece of image analysis software (WinROOF, manufactured by MITANI CORPORATION). The circle-equivalent diameter is 2√(projected area/π).

The silica composite particles according to the exemplary embodiment may be applied to various fields such as toners, cosmetics, or abrasives.

Method of Producing Silica Composite Particles

A method of producing the silica composite particles according to the exemplary embodiment is an example of the production method for obtaining the silica composite particles according to the exemplary embodiment described above and is specifically as follows.

The method of producing the silica composite particles according to the exemplary embodiment includes: preparing an alkali catalyst solution containing an alkali catalyst in a solvent containing alcohol; supplying tetraalkoxysilane and an alkali catalyst to the alkali catalyst solution to form silica particles; and supplying a mixed solution of an aluminum compound in which an organic group is bonded to an aluminum atom through an oxygen atom, and alcohol, to the alkali catalyst solution in which the silica particles are formed, to subject the silica particles to surface treatment with the aluminum compound.

That is, the method of producing the silica composite particles according to the exemplary embodiment is a method in which an alcohol diluent obtained by diluting the aluminum compound with alcohol is supplied into the solution in which silica particles are formed by a sol-gel method and the silica particles are subjected to surface treatment with the aluminum compound to obtain silica composite particles.

With the method of producing the silica composite particles according to the exemplary embodiment, the silica composite particles according to the exemplary embodiment may be obtained using the aforementioned method. The reason is not clear, but when the silica particles are subjected to surface treatment with the aluminum compound by using not only the aluminum compound but also the alcohol diluent obtained by diluting an aluminum compound with alcohol, reactivity of a silanol group on the surface of the silica particles is properly activated and a reactive group of the aluminum compound is also activated. Therefore, it is considered that silica composite particles having desired average particle size and particle size distribution are formed.

In addition, it is considered that silica composite particles having desired aluminum coverage are formed by adjusting the concentration of the aluminum compound in the alcohol diluent to 0.05% by weight to 10% by weight.

In the method of producing the silica composite particles according to the exemplary embodiment, the sol-gel method in which silica particles are formed is not particularly limited and a known method is adopted.

On the other hand, the following method may be adopted to obtain the silica composite particles according to the exemplary embodiment, and the following method is preferably adopted particularly to obtain silica composite particles having an irregular shape with an average circularity of from 0.5 to 0.85.

Hereinafter, the method of producing the silica composite particles having an irregular shape is referred to as a “method of producing the silica composite particles according to the exemplary embodiment”, and the description is made.

The method of producing the silica composite particles according to the exemplary embodiment includes the following alkali catalyst solution preparing step, the following silica particle forming step, and the following surface treatment step.
Alkali catalyst solution preparing step: preparing an alkali catalyst solution containing an alkali catalyst at a concentration of from 0.6 mol/L to 0.85 mol/L in a solvent containing alcohol.
Silica particle forming step: supplying tetraalkoxysilane in a supply amount of from 0.0005 mol/(mol·min) to 0.01 mol/(mol·min) with respect to the alcohol and an alkali catalyst in a supply amount of from 0.1 mol/(mol·min) to 0.4 mol/(mol·min) with respect to a total supply amount of the tetraalkoxysilane supplied per one minute to the alkali catalyst solution, to form silica particles.
Surface treatment step: supplying a mixed solution of an aluminum compound in which an organic group is bonded to an aluminum atom through an oxygen atom, and alcohol, with a concentration of the aluminum compound of from 0.05% by weight to 10% by weight, to the alkali catalyst solution in which the silica particles are formed, to subject the silica particles to surface treatment with the aluminum compound.

The method of producing the silica composite particles according to the exemplary embodiment is a method in which silica particles are formed by respectively supplying tetraalkoxysilane as a component forming the silica particles and an alkali catalyst as a catalyst in the aforementioned supply amounts to the alkali catalyst solution containing an alkali catalyst and alcohol at the aforementioned concentration, to allow tetraalkoxysilane to undergo a reaction and then, supplying a mixed solution of an aluminum compound and alcohol in the solution in which the silica particles are formed to subject the silica particles to surface treatment with the aluminum compound, to obtain silica composite particles.

In the method of producing the silica composite particles according to the exemplary embodiment, the occurrence of coarse aggregates is reduced and irregularly shaped silica composite particles are obtained by the technique described above. The reason for this is not clear, but is considered to be as follows.

First, when tetraalkoxysilane and an alkali catalyst are each supplied to an alkali catalyst solution in which an alkali catalyst is contained in a solvent containing alcohol, the tetraalkoxysilane supplied to the alkali catalyst solution is allowed to undergo a reaction, and nuclear particles are formed. At this time, when the concentration of the alkali catalyst in the alkali catalyst solution is within the aforementioned range, it is considered that nuclear particles having an irregular shape may be formed while preventing formation of coarse aggregates such as secondary aggregates. This is considered to be based on the following mechanism. In addition to catalytic action thereof, the alkali catalyst coordinates with the surface of the formed nuclear particles and contributes to the shape and dispersion stability of the nuclear particles. However, in the case where the supply amount is within the aforementioned range, irregularity occurs when the surface of the nuclear particle is covered by the alkali catalyst (that is, the alkali catalyst is unevenly distributed on the surface of the nuclear particles and attached to the surface). Accordingly, even though the dispersion stability of the nuclear particles is maintained, partial bias in the surface tension and chemical affinity of the nuclear particles occur, and thus nuclear particles having an irregular shape are formed.

When the tetraalkoxysilane and the alkali catalyst are each continuously supplied, the formed nuclear particles grow as a result of the reaction of the tetraalkoxysilane, and thus, the silica composite particles are obtained. It is considered that when these supplies of the tetraalkoxysilane and the alkali catalyst are carried out in the supply amounts in the aforementioned range, the dispersion of the nuclear particles is maintained while the partial bias in the tension and chemical affinity at the nuclear particle surface is also maintained, therefore, the nuclear particles having an irregular shape grow into particles while maintaining the irregular shape, with the formation of coarse aggregates such as secondary aggregates being suppressed, and as a result, silica composite particles having an irregular shape are formed.

Here, it is considered that the supply amount of the tetraalkoxysilane is related to the particle size distribution and the shape distribution of the silica composite particles in the nuclear particle growth process. It is considered that, by controlling the supply amount of the tetraalkoxysilane to the aforementioned range, the contact probability between the tetraalkoxysilane molecules added dropwise is reduced, and the tetraalkoxysilane molecules are evenly supplied to the respective nuclear particles before the tetraalkoxysilane molecules react with each other. Thus, it is considered that the reaction of the tetraalkoxysilane with the nuclear particles may evenly take place. As a result, it is considered that the variation in particle growth may be suppressed and the silica composite particles having a narrow distribution width of particle size and shape may be produced. When the supply amount of the tetraalkoxysilane is too small, the contact probability between the tetraalkoxysilane molecules is reduced, and thus, the number of small particles is increased. On the other hand, when the supply amount of the tetraalkoxysilane is too large, reaction control is difficult and aggregation occurs, and thus, the number of large particles is increased. Therefore, the particle size distribution and the shape distribution tend to become wide when the supply amount of the tetraalkoxysilane is too small or too large.

In addition, it is considered that the average particle size of the silica composite particles depends on the initial temperature at the time of adding the tetraalkoxysilane, and the lower the temperature is, the smaller the particle size is.

From the above mechanism, it is considered that the silica composite particles having an irregular shape according to the exemplary embodiment may be obtained in the method of producing the silica composite particles according to the exemplary embodiment.

Furthermore, it is considered that in the method of producing the silica composite particles according to the exemplary embodiment, nuclear particles having an irregular shape are formed, and the nuclear particles are allowed to grow while maintaining the irregular shape, to thereby generate the silica composite particles. Therefore, it is considered that silica composite particles having an irregular shape, which is strong against a mechanical load, less likely to be destructed, that is, which has high shape-stability against a mechanical load, are obtained.

Further, in the method of producing the silica composite particles according to the exemplary embodiment, when tetraalkoxysilane and an alkali catalyst are each supplied to an alkali catalyst solution, the reaction of tetraalkoxysilane is caused, and thereby the formation of particles is achieved. Therefore, the total amount of the alkali catalyst used is reduced as compared with the case of producing silica composite particles having an irregular shape by a sol-gel method in the related art, and as a result, the omission of a step of removing an alkali catalyst is also realized. This is particularly favorable in the case of applying the silica composite particles to a product that requires high purity.

Hereinafter, the alkali catalyst solution preparing step, silica particle forming step, and surface treatment step will be described.

Alkali Catalyst Solution Preparing Step

The alkali catalyst solution preparing step is a step of preparing a solvent containing alcohol and mixing an alkali catalyst to the solvent to prepare an alkali catalyst solution.

The solvent containing alcohol may be formed only of alcohol or may be a mixed solvent of alcohol and other solvents. Examples of other solvents include water, ketones such as acetone, methyl ethyl ketone or methyl isobutyl ketone, cellosolves such as methyl cellosolve, ethyl cellosolve, butyl cellosolve or cellosolve acetate, and ethers such as dioxane or tetrahydrofuran. In a case of a mixed solvent, the ratio of alcohol with respect to the other solvents may be 80% by weight or more (preferably 90% by weight or more).

Examples of the alcohol include lower alcohols, such as methanol or ethanol.

The alkali catalyst is a catalyst used for promoting the reaction of the tetraalkoxysilane (hydrolysis reaction or condensation reaction), and examples thereof include basic catalysts such as ammonia, urea, monoamine or a quaternary ammonium salt, and ammonia is particularly preferable.

The concentration (content) of the alkali catalyst is from 0.6 mol/L to 0.85 mol/L, preferably from 0.63 mol/L to 0.78 mol/L, and more preferably from 0.66 mol/L to 0.75 mol/L.

When the concentration of the alkali catalyst is less than 0.6 mol/L, the dispersibility of the formed nuclear particles during the growth becomes unstable. As a result, coarse aggregates such as secondary aggregates are formed or gelation may occur, and the particle size distribution becomes wide or plural distribution peaks are shown in some cases.

On the other hand, when the concentration of the alkali catalyst is greater than 0.85 mol/L, stability of the formed nuclear particles is excessively high to generate spherical nuclear particles, and nuclear particles having an irregular shape are less likely to be obtained. As a result, it is difficult to obtain silica particles and silica composite particles having an irregular shape with an average circularity of 0.85 or less.

The concentration of the alkali catalyst is a concentration with respect to the alcohol catalyst solution (a total amount of the solvent containing alcohol and alkali catalyst).

Silica Particle Forming Step

The silica particle forming step is a step of respectively supplying tetraalkoxysilane and an alkali catalyst to an alkali catalyst solution in the aforementioned supply amounts and allowing tetraalkoxysilane to undergo a reaction in the alkali catalyst solution (hydrolysis reaction or condensation reaction) to generate silica particles.

In the silica particle forming step, the silica particles are formed by forming nuclear particles by the reaction of the tetraalkoxysilane at an early stage of supplying the tetraalkoxysilane (nuclear particle formation stage) and then, growing the nuclear particles (nuclear particles growth stage).

Examples of tetraalkoxysilane include tetramethoxysilane, tetraethoxysilane, tetrapropoxysilane, and tetrabutoxysilane. From the viewpoint of controllability of the reaction rate or the shape, particle size and particle size distribution of the silica particles and silica composite particles to be obtained, tetramethoxysilane and tetraethoxysilane are preferable.

The supply amount of tetraalkoxysilane is from 0.0005 mol/(mol·min) to 0.01 mol/(mol·min) with respect to the alcohol in the alkali catalyst solution.

This means that tetraalkoxysilane is supplied in a supply amount from 0.0005 mol to 0.01 mol per minute with respect to 1 mol of the alcohol used in the alkali catalyst solution preparing step.

When the supply amount of the tetraalkoxysilane is less than 0.0005 mol/(mol·min), the contact probability between the tetraalkoxysilane molecules added dropwise is reduced. However, it takes a long time to complete the dropwise addition of the total supply amount of tetraalkoxysilane, and thus, production efficiency is low.

When the supply amount of the tetraalkoxysilane is greater than 0.01 mol/(mol·min), it is considered that the reaction between the tetraalkoxysilane molecules is caused before the tetraalkoxysilane added dropwise and the nuclear particles start to undergo a reaction with each other. Therefore, since uneven distribution of tetraalkoxysilane supplied to the nuclear particles is encouraged and the variation in the growth of the nuclear particles is caused, the distribution width of the particle size and the shape may be increased.

For the aforementioned reasons, the supply amount of the tetraalkoxysilane is preferably from 0.001 mol/(mol·min) to 0.009 mol/(mol·min), more preferably from 0.002 mol/(mol·min) to 0.008 mol/(mol·min), and even more preferably from 0.003 mol/(mol·min) to 0.007 mol/(mol·min).

The particle size of the silica composite particles depends on the kind of tetraalkoxysilane or the reaction conditions, but by setting the total supply amount of tetraalkoxysilane, for example, to 1.08 mol or greater with respect to 1 L of the silica composite particle dispersion, primary particles having a particle size of 100 nm or greater are likely to be obtained, and by setting the total supply amount of tetraalkoxysilane to 5.49 mol or less with respect to 1 L of the silica composite particle dispersion, primary particles having a particle size of 500 nm or less are likely to be obtained.

Examples of the alkali catalyst supplied to the alkali catalyst solution include those as described above in the section on the alkali catalyst solution preparing step. The alkali catalyst supplied together with the tetraalkoxysilane may be the same as or different from the alkali catalyst that has been contained in the alkali catalyst solution in advance, but is preferably the same as the alkali catalyst that has been contained in the alkali catalyst solution in advance.

The supply amount of the alkali catalyst is from 0.1 mol/(mol·min) to 0.4 mol/(mol·min) with respect to a total supply amount of the tetraalkoxysilane supplied per one minute.

This means that the alkali catalyst is supplied in a supply amount from 0.001 mol to 0.01 mol per minute based on 1 mol of the total supply amount of tetraalkoxysilane supplied per minute.

When the supply amount of the alkali catalyst is less than 0.1 mol/(mol·min), dispersibility of the nuclear particles in the growth process becomes unstable. As a result, coarse aggregates such as secondary aggregates are formed, or gelation may occur, and thus, the control of the particle size distribution or the control of the circularity of the silica composite particles may be difficult.

On the other hand, when the supply amount of the alkali catalyst is greater than 0.4 mol/(mol·min), the formed nuclear particles are excessively stabilized, and even when nuclear particles having an irregular shape are formed in the nuclear particle formation stage, the nuclear particles grow into a spherical shape during the nuclear particle growth stage. Therefore, it is difficult to obtain silica particles and silica composite particles having an irregular shape.

For the aforementioned reasons, the supply amount of the alkali catalyst is preferably from 0.14 mol/(mol·min) to 0.35 mol/(mol·min) and more preferably from 0.18 mol/(mol·min) to 0.3 mol/(mol·min).

As the method of respectively supplying tetraalkoxysilane and the alkali catalyst to the alkali catalyst solution, the supply method may be a method of continuously supplying the materials or may be a method of intermittently supplying the materials.

In the silica particle forming step, the temperature of the alkali catalyst solution (the temperature during supply) may be, for example, from 5° C. to 50° C. and preferably from 15° C. to 40° C.

Surface Treatment Step

The surface treatment step is a step of supplying a mixed solution of an aluminum compound and alcohol to the alkali catalyst solution in which silica particles are formed through the silica particle forming step to subject the silica particles to surface treatment with the aluminum compound.

Specifically, for example, an organic group (for example, an alkoxy group) of the aluminum compound is allowed to undergo a reaction with a silanol group on the surface of the silica particles, and the surface of the silica particles is treated with the aluminum compound.

Examples of the aluminum compound (the aluminum compound in which an organic group is bonded to an aluminum atom through an oxygen atom) include: aluminum alkoxides such as aluminum methoxide, aluminum ethoxide, aluminum n-propoxide, aluminum i-propoxide, aluminum n-butoxide, aluminum i-butoxide, aluminum sec-butoxide and aluminum tert-butoxide; chelates such as aluminum ethylacetoacetate diisopropylate, aluminum tris-ethylacetoacetate, aluminum bis-ethylacetoacetate-monoacetylacetonate and aluminum tris-acetylacetonate; aluminum oxide acylates such as aluminum oxide 2-ethylhexanoate and aluminum oxide laurate; aluminum complexes of β-diketones such as acetylacetonate; aluminum complexes of β-ketoesters such as ethyl acetylacetonate; aluminum complexes of amines such as triethanolamine; and aluminum complexes of carboxylic acids such as acetic acid, butyric acid, lactic acid, and citric acid.

The aluminum compound is preferably an aluminum compound having one or more (preferably two or more) alkoxy groups from the viewpoint of controllability of reaction rate, or the shape, particle size, and particle size distribution of the silica composite particles to be obtained. That is, the aluminum compound is preferably an aluminum compound in which one or more (preferably two or more) alkoxy groups (alkyl groups bonded to an aluminum atom through one oxygen atom) are bonded to an aluminum atom. The number of carbon atoms in the alkoxy group is preferably 8 or less and more preferably from 2 to 4, from the viewpoint of the controllability of the reaction rate or the shape, particle size, and particle size distribution of the silica composite particles to be obtained.

Preferable specific examples of the aluminum compound include chelates such as aluminum ethylacetoacetate diisopropylate, aluminum tris-ethylacetoacetate, aluminum bis-ethylacetoacetate-monoacetylacetonate, and aluminum tris-acetylacetonate.

Examples of the alcohol include methanol, ethanol, n-propanol, isopropanol, and butanol.

When the aluminum compound is a compound having an alkoxy group, from the viewpoint of the controllability of the reaction rate of the aluminum compound or the shape, particle size, and particle size distribution of the silica composite particles to be obtained, the alcohol may preferably be an alcohol in which the number of carbon atoms is smaller than the number of carbon atoms in the alkoxy group of the aluminum compound (specifically, for example, the difference between carbon atoms is from 2 to 4).

The alcohol may be the same as or different from the alcohol contained in the alkali catalyst solution, but is preferably the same as the alcohol contained in the alkali catalyst solution.

In the mixed solution of the aluminum compound and alcohol, the concentration of the aluminum compound is from 0.05% by weight to 10% by weight, preferably from 0.1% by weight to 5% by weight, and more preferably from 0.5% by weight to 3% by weight.

The supply amount of the mixed solution of the aluminum compound and alcohol may be, for example, an amount in which a total amount of the aluminum compound is from 1.0 part to 55 parts (preferably from 1.5 parts to 40 parts, more preferably from 2.0 parts to 20 parts) with respect to 100 parts of the silica particles.

When the supply amount of the mixed solution is within the aforementioned range, the reaction rate of the aluminum compound is controlled, and gelation is less likely to occur. Therefore, it is likely to obtain silica composite particles having a desired aluminum coverage, particle size, particle size distribution, and shape.

The condition for the surface treatment of the silica particles with the aluminum compound is not particularly limited, and for example, the aluminum compound is allowed to undergo a reaction at a temperature in the range from 5° C. to 50° C. under stirring.

The silica composite particles obtained through the surface treatment step are obtained in the form of a dispersion, but may be used as a dispersion of the silica composite particles as is or as a powder of the silica composite particles extracted by removing the solvent.

When the silica composite particles are used as a silica composite particle dispersion, the solid concentration of silica composite particles may be adjusted by diluting the dispersion with water or alcohol or by concentrating the dispersion. The silica composite particle dispersion may be used after substituting the solvent with water-soluble organic solvents such as other alcohols, esters, or ketones.

When the silica composite particles are used as a powder, the solvent is removed from the dispersion of the silica composite particles. Examples of a method of removing the solvent include known methods such as 1) a method of removing the solvent by filtration, centrifugal separation, and distillation, and then drying the resultant by a vacuum dryer, a tray dryer, or the like and 2) a method of directly drying a slurry by a fluidized bed dryer, a spray dryer or the like. The drying temperature is not particularly limited, but is preferably 200° C. or lower. When the drying temperature is higher than 200° C., it is likely to cause bonding among the primary particles or forming of coarse particles due to the condensation of a silanol group remaining on the surface of the silica composite particles.

The dried silica composite particles may preferably be pulverized or sieved to remove coarse particles or aggregates therefrom. The pulverization method is not particularly limited and may be carried out by a dry pulverizer, such as a jet mill, a vibration mill, a ball mill, or a pin mill. The sieving method may be carried out by known devices, such as a vibration sieve or a wind classifier.

Examples of the method of removing the solvent of the silica composite particle dispersion include a method of bringing supercritical carbon dioxide into contact with the silica composite particle dispersion to remove the solvent. Specifically, for example, the silica composite particle dispersion is put into a sealed reaction vessel. Thereafter, liquefied carbon dioxide is put into the sealed reaction vessel and heated, and the pressure of the inside of the reaction vessel is elevated by a high pressure pump to bring the carbon dioxide into a supercritical state. Further, while the temperature and pressure of the sealed reaction vessel are maintained at the critical point of the carbon dioxide or higher, supercritical carbon dioxide is put into and discharged from the sealed reaction vessel at the same time and flowed into the silica particle dispersion. By this, while the supercritical carbon dioxide dissolves and entrains the solvent (an alcohol and water) and at the same time, and is discharged into the outside of the silica composite particle dispersion (the outside of the sealed reaction vessel) to remove the solvent.

The method of producing the silica composite particles according to the exemplary embodiment may further include a step of subjecting the silica particles (silica composite particles), which have been subjected to surface treatment with the aluminum compound, to a surface treatment with a hydrophobizing agent (hydrophobization treatment step). Examples of the surface treatment method include 1) a method of adding a hydrophobizing agent into a silica composite particle dispersion, and allowing the mixture to undergo a reaction under stirring at a temperature, for example, in the range of from 30° C. to 80° C. and 2) a method of stirring powdered silica composite particles in a treatment tank such as a Henschel mixer or a fluidized bed, adding a hydrophobizing agent thereto, and heating the inside of the treatment tank to a temperature of, for example, from 80° C. to 300° C. and gasifying the hydrophobizing agent to undergo a reaction.

When the method of producing the silica composite particles according to the exemplary embodiment includes the hydrophobization treatment step, the hydrophobization treatment step is preferably a step of subjecting the surface of the silica composite particles to hydrophobization treatment with a hydrophobizing agent in supercritical carbon dioxide.

Supercritical carbon dioxide is carbon dioxide in the state under a temperature and pressure, each of which is equal to or higher than the critical point and has both of gas diffusivity and liquid-like solubility. Supercritical carbon dioxide has properties of extremely low interfacial tension.

When the step of subjecting the surface of the silica composite particles to hydrophobization treatment with a hydrophobizing agent is carried out in supercritical carbon dioxide, it is considered that the hydrophobizing agent is dissolved in the supercritical carbon dioxide and is likely to deeply reach the holes on the surface of the silica composite particles in a dispersed manner, together with the supercritical carbon dioxide having extremely low interfacial tension. As a result, it is considered that the hydrophobization treatment is carried out by the hydrophobizing agent on the surface of the silica composite particles and also carried out deep into the holes of the silica composite particles.

Accordingly, since the hydrophobization treatment is carried out deep into the holes of the silica composite particles, of which the surface has been subjected to hydrophobization treatment in supercritical carbon dioxide, it is considered that the amount of moisture absorbed into and retained on the surface of the silica composite particle surfaces is small and, thus, dispersibility into a hydrophobic target to be attached (a hydrophobic resin, a hydrophobic solvent and the like) is excellent.

Hereinafter, the hydrophobization treatment step in supercritical carbon dioxide will be described.

Hydrophobization Treatment Step in Supercritical Carbon Dioxide

Specifically, for example, the silica composite particles are put into a sealed reaction vessel in the step, and then, a hydrophobizing agent is added thereto. Thereafter, liquefied carbon dioxide is put into the sealed reaction vessel and heated, and the pressure of the inside of the reaction vessel is elevated by a high pressure pump to bring the carbon dioxide into a supercritical state. Then, the hydrophobizing agent is allowed to undergo a reaction in supercritical carbon dioxide, and the silica composite particles are subjected to hydrophobization treatment. After the reaction is completed, the pressure of the inside of the sealed reaction vessel is reduced, and the materials are cooled.

The density of supercritical carbon dioxide may be, for example, from 0.1 g/ml to 0.6 g/ml, preferably from 0.1 g/ml to 0.5 g/ml, and more preferably from 0.2 g/ml to 0.3 g/ml.

The density of supercritical carbon dioxide is adjusted by temperature and pressure.

The temperature condition of the hydrophobization treatment, that is, the temperature of supercritical carbon dioxide may be, for example, from 80° C. to 300° C., preferably 100° C. to 300° C., and more preferably from 150° C. to 250° C.

The pressure condition of the hydrophobization treatment, that is, the pressure of supercritical carbon dioxide may be a condition that satisfies the aforementioned density, but may be, for example, from 8 MPa to 30 MPa, preferably from 10 MPa to 25 MPa, and more preferably from 15 MPa to 20 MPa.

The amount (feed amount) of the silica composite particles with respect to the volume of the sealed reaction vessel may be, for example, from 50 g/L to 600 g/L, preferably from 100 g/L to 500 g/L, and preferably from 150 g/L to 400 g/L.

The amount of the hydrophobizing agent used may be from 1% by weight to 60% by weight, preferably from 5% by weight to 40% by weight, and more preferably from 10% by weight to 30% by weight, with respect to the silica composite particles.

Examples of the hydrophobizing agent include known organic silicon compounds having an alkyl group (for example, a methyl group, an ethyl group, a propyl group, or a butyl group). Specific examples thereof include: silane compounds such as methyltrimethoxysilane, dimethyldimethoxysilane, trimethylchlorosilane, and trimethylmethoxysilane; and silazane compounds such as hexamethyldisilazane and tetramethyldisilazane. The hydrophobizing agents may be used singly or in combination of two or more kinds thereof.

Among these hydrophobizing agents, organic silicon compounds having a trimethyl group, such as trimethylmethoxysilane or hexamethyldisilazane, are preferable.

### EXAMPLES

Hereinafter, the present invention will be described in detail with reference to the Examples. However, these Examples are not intended to limit the scope of the present invention. Unless otherwise specified, “parts” and “%” are on a weight basis.

### Example 1

### Alkali Catalyst Solution Preparing Step (Preparation of Alkali Catalyst Solution)

400 parts of methanol and 70 parts of 10% ammonia water (NH₄OH) are put in a glass reaction vessel having a stirrer, a dropping nozzle, and a thermometer and mixed under stirring to obtain an alkali catalyst solution. At this time, the concentration of alkali catalyst (that is, the concentration of NH₃, NH₃[mol]/(NH₃+methanol+water) [L]) in the alkali catalyst solution is 0.71 mol/L.

Silica Particles Forming Step (Preparation of Suspension of Silica Particles)

As tetraalkoxysilane, tetramethoxysilane (TMOS) is prepared. In addition, as an alkali catalyst, ammonia water (NH₄OH) containing a catalyst (NH₃) at a concentration of 3.8% is prepared.

The temperature of the alkali catalyst solution is adjusted to 25° C., and the alkali catalyst solution is substituted with nitrogen. Then, while stirring the alkali catalyst solution at 120 rpm, 192 parts of TMOS and 152 parts of 3.8% ammonia water are started to be added dropwise to the alkali catalyst solution at the same time over 60 minutes to obtain a suspension of silica particles (a silica particle suspension).

At this time, the supply amount of TMOS per minute is adjusted to be 0.0018 mol/(mol·min) with respect to a total amount (mol) of methanol in the alkali catalyst solution.

The supply amount of 3.8% ammonia water per minute is adjusted to be 0.27 mol/(mol·min) with respect to a total supply amount of TMOS per minute.

Surface Treatment Step of Silica Particles

An alcohol diluent is obtained by diluting the aluminum compound (aluminum ethylacetoacetate diisopropylate, manufactured by Wako Pure Chemical Industries, Ltd.) with butanol so as to have a concentration of 1% by weight.

The temperature of the silica particle suspension is adjusted to 25° C., and the alcohol diluent of which the temperature is adjusted to 25° C. is added. At this time, the alcohol diluent is added such that the content of the aluminum compound becomes 8.6 parts with respect to 100 parts of the silica particles.

Subsequently, the aluminum compound is allowed to undergo a reaction with the surface of the silica particles by stirring the mixture for 30 minutes, and thus the silica particles are subjected to surface treatment, to obtain a suspension of silica composite particles (silica composite particle suspension).

Hydrophobization Treatment Step of Silica Composite Particles (Hydrophobization Treatment in Supercritical Carbon Dioxide)

The temperature of the inside of the sealed reaction vessel in which the silica composite particle suspension is accommodated is elevated to 80° C. by a heater. Thereafter, the pressure of the reaction vessel is elevated to 20 MPa by a carbon dioxide pump, and supercritical carbon dioxide is flowed into the sealed reaction vessel (an amount to be put in and discharged of 170 L/min/m³). The solvent of the silica composite particle suspension is removed to obtain a powder of the silica composite particles.

4.0 parts of hexamethyldisilazane is put into the sealed reaction vessel in which the powder of the silica composite particles is accommodated (a feed amount of silica composite particles of 200 g/L with respect to the volume of the vessels). Subsequently, the sealed reaction vessel is filled with liquefied carbon dioxide. The temperature of the reaction vessel is elevated to 160° C. by a heater, and then, the pressure of the reaction vessel is elevated to 20 MPa. At the time point when the temperature reaches 160° C. and the pressure reaches 20 MPa and carbon dioxide is in a supercritical state (a density of supercritical carbon dioxide of 0.163 g/ml), the stirrer is operated at 200 rpm, and the materials therein are retained for 30 minutes. Subsequently, the pressure is released to atmospheric pressure, and the materials are cooled to room temperature (25° C.). Then, the stirrer is stopped to take out a powder of silica composite particles of which the surface has been subjected to the hydrophobization treatment (hydrophobic silica composite particle).

### Examples 2 to 30, Comparative Examples 1 to 5

Hydrophobic silica composite particles are obtained in the same manner as Example 1, except that various conditions in the alkali catalyst solution preparing step, the silica particle forming step, the surface treatment step, and the hydrophobization treatment step are changed as indicated in Table 1. However, silica particles are not subjected to the surface treatment step in Comparative Example 3.

In Example 18, hydrophobic silica composite particles are obtained using aluminum tris-ethylacetoacetate (manufactured by Wako Pure Chemical Industries, Ltd.) as an aluminum compound, instead of aluminum ethylacetoacetate diisopropylate.

In Example 19, hydrophobic silica composite particles are obtained using aluminum tris-acetylacetonate (manufactured by Wako Pure Chemical Industries, Ltd.) as an aluminum compound, instead of aluminum ethylacetoacetate diisopropylate.

In Example 20, hydrophobic silica composite particles are obtained using aluminum n-propoxide (manufactured by Wako Pure Chemical Industries, Ltd.) as an aluminum compound, instead of aluminum ethylacetoacetate diisopropylate.

In Table 1, aluminum ethylacetoacetate diisopropylate is abbreviated as ALCH, aluminum tris-ethylacetoacetate is abbreviated as ALCH-TR, aluminum tris-acetylacetonate is abbreviated as ALTAA, and aluminum n-propoxide is abbreviated as ALnP.

TABLE 1

| | | | | | | | Silica particle forming step | | |
|---|---|---|---|---|---|---|---|---|---|
| | | | | | | | (supply condition of TMOS and ammonia water) | | |
| | | | | | | | | Supply amount | |
| | | | | | | | | of TMOS | |
| | Alkali catalyst solution preparing step | | | | | | | [supply amount | |
| | (alkali catalyst solution composition) | | | | | | Total | with respect to | |
| | | 10% | | | | | supply | amount of | |
| | | ammonia | Number of | Number of | | | amount of | alcohol of | Dropwise |
| | Methanol | water | moles of | moles of | Solvent | NH₃ | TMOS | alkali catalyst | addition |
| | Parts by | Parts by | methanol | NH₃ | volume | amount | Parts by | solution] | time |
| | weight | weight | mol | mol | L | mol/L | weight | mol/mol · min | min |
| Example 1 | 400 | 70 | 12.5 | 0.41 | 582 | 0.71 | 192 | 0.0018 | 60 |
| Example 2 | 400 | 70 | 12.5 | 0.41 | 582 | 0.71 | 146 | 0.0014 | 46 |
| Example 3 | 400 | 70 | 12.5 | 0.41 | 582 | 0.71 | 282 | 0.0025 | 88 |
| Example 4 | 400 | 70 | 12.5 | 0.41 | 582 | 0.71 | 140 | 0.0013 | 44 |
| Example 5 | 400 | 70 | 12.5 | 0.41 | 582 | 0.71 | 119 | 0.0012 | 37 |
| Example 6 | 400 | 70 | 12.5 | 0.41 | 582 | 0.71 | 317 | 0.0028 | 99 |
| Example 7 | 400 | 70 | 12.5 | 0.41 | 582 | 0.71 | 451 | 0.0040 | 141 |
| Example 8 | 400 | 70 | 12.5 | 0.41 | 582 | 0.71 | 115 | 0.0011 | 36 |
| Example 9 | 400 | 70 | 12.5 | 0.41 | 582 | 0.71 | 102 | 0.00099 | 32 |
| Example 10 | 400 | 70 | 12.5 | 0.41 | 582 | 0.71 | 483 | 0.0043 | 151 |
| Example 11 | 400 | 70 | 12.5 | 0.41 | 582 | 0.71 | 901 | 0.0079 | 282 |
| Example 12 | 400 | 70 | 12.5 | 0.41 | 582 | 0.71 | 233 | 0.0021 | 73 |
| Example 13 | 400 | 70 | 12.5 | 0.41 | 582 | 0.71 | 183 | 0.0017 | 57 |
| Example 14 | 400 | 70 | 12.5 | 0.41 | 582 | 0.71 | 212 | 0.0019 | 66 |
| Example 15 | 400 | 70 | 12.5 | 0.41 | 582 | 0.71 | 158 | 0.0015 | 49 |
| Example 16 | 400 | 70 | 12.5 | 0.41 | 582 | 0.71 | 147 | 0.0014 | 46 |
| Example 17 | 400 | 70 | 12.5 | 0.41 | 582 | 0.71 | 183 | 0.0017 | 57 |
| Example 18 | 400 | 70 | 12.5 | 0.41 | 582 | 0.71 | 192 | 0.0018 | 60 |
| Example 19 | 400 | 70 | 12.5 | 0.41 | 582 | 0.71 | 192 | 0.0018 | 60 |
| Example 20 | 400 | 70 | 12.5 | 0.41 | 582 | 0.71 | 192 | 0.0018 | 60 |
| Example 21 | 400 | 70 | 12.5 | 0.41 | 582 | 0.71 | 192 | 0.0018 | 60 |
| Example 22 | 400 | 70 | 12.5 | 0.41 | 582 | 0.71 | 192 | 0.0018 | 60 |
| Example 23 | 400 | 70 | 12.5 | 0.41 | 582 | 0.71 | 192 | 0.0018 | 60 |
| Example 24 | 400 | 70 | 12.5 | 0.41 | 582 | 0.71 | 192 | 0.0018 | 60 |
| Example 25 | 400 | 70 | 12.5 | 0.41 | 582 | 0.71 | 192 | 0.0018 | 60 |
| Example 26 | 400 | 70 | 12.5 | 0.41 | 582 | 0.71 | 192 | 0.0018 | 60 |
| Example 27 | 400 | 70 | 12.5 | 0.41 | 582 | 0.71 | 192 | 0.0018 | 60 |
| Example 28 | 400 | 70 | 12.5 | 0.41 | 582 | 0.71 | 192 | 0.0018 | 60 |
| Example 29 | 400 | 70 | 12.5 | 0.41 | 582 | 0.71 | 192 | 0.0018 | 60 |
| Example 30 | 400 | 70 | 12.5 | 0.41 | 582 | 0.71 | 192 | 0.0018 | 60 |
| Comparative | 400 | 70 | 12.5 | 0.41 | 582 | 0.71 | 100 | 0.00097 | 31 |
| Example 1 | | | | | | | | | |
| Comparative | 400 | 70 | 12.5 | 0.41 | 582 | 0.71 | 1034 | 0.0090 | 323 |
| Example 2 | | | | | | | | | |
| Comparative | 400 | 70 | 12.5 | 0.41 | 582 | 0.71 | 192 | 0.0018 | 60 |
| Example 3 | | | | | | | | | |
| Comparative | 400 | 70 | 12.5 | 0.41 | 582 | 0.71 | 192 | 0.0018 | 60 |
| Example 4 | | | | | | | | | |
| Comparative | 400 | 70 | 12.5 | 0.41 | 582 | 0.71 | 192 | 0.0018 | 60 |
| Example 5 | | | | | | | | | |

| | | | | Surface treatment step (alcohol diluent | | | |
|---|---|---|---|---|---|---|---|
| | Silica particle forming step | | | composition and supply condition) | | | |
| | (supply condition of TMOS and ammonia water) | | | | | Supply | |
| | | Supply amount | | | | amount of Al | |
| | Total supply | of NHs [supply | | | | compound | |
| | amount of | amount with | | | Concentration | [with respect | |
| | 3.8% | respect to total | Number of | | of Al | to 100 parts | |
| | ammonia | supply amount | rotations | | compound of | of silica | Hydrophobization |
| | water | of TMOS per | during | Kind of Al | alcohol | particles] | treatment step |
| | Parts by | minute] | stirring | compound | diluent | Parts by | Hexamethyldisilazane |
| | weight | mol/mol · min | rpm | — | % by weight | weight | Parts by weight |
| Example 1 | 152 | 0.27 | 120 | ALCH | 1 | 8.6 | 4.0 |
| Example 2 | 116 | 0.28 | 120 | ALCH | 1 | 13.3 | 6.2 |
| Example 3 | 223 | 0.27 | 120 | ALCH | 1 | 5.8 | 2.7 |
| Example 4 | 111 | 0.28 | 120 | ALCH | 1 | 14.5 | 6.7 |
| Example 5 | 94 | 0.28 | 120 | ALCH | 1 | 21.9 | 10.2 |
| Example 6 | 251 | 0.27 | 120 | ALCH | 1 | 5.2 | 2.4 |
| Example 7 | 356 | 0.26 | 120 | ALCH | 1 | 4.1 | 1.9 |
| Example 8 | 91 | 0.28 | 120 | ALCH | 1 | 24.7 | 11.4 |
| Example 9 | 81 | 0.28 | 120 | ALCH | 1 | 43.2 | 20.0 |
| Example 10 | 382 | 0.26 | 120 | ALCH | 1 | 3.9 | 1.8 |
| Example 11 | 712 | 0.25 | 120 | ALCH | 1 | 2.8 | 1.3 |
| Example 12 | 184 | 0.27 | 105 | ALCH | 1 | 6.9 | 3.2 |
| Example 13 | 145 | 0.28 | 110 | ALCH | 1 | 9.2 | 4.3 |
| Example 14 | 167 | 0.27 | 115 | ALCH | 1 | 7.7 | 3.6 |
| Example 15 | 125 | 0.28 | 130 | ALCH | 1 | 11.5 | 5.3 |
| Example 16 | 116 | 0.28 | 135 | ALCH | 1 | 13.1 | 6.1 |
| Example 17 | 145 | 0.28 | 145 | ALCH | 1 | 9.2 | 4.3 |
| Example 18 | 152 | 0.27 | 120 | ALCH-TR | 1 | 8.6 | 4.0 |
| Example 19 | 152 | 0.27 | 120 | ALTAA | 1 | 8.6 | 4.0 |
| Example 20 | 152 | 0.27 | 120 | ALnP | 1 | 8.6 | 4.0 |
| Example 21 | 152 | 0.27 | 120 | ALCH | 1 | 1.5 | 4.0 |
| Example 22 | 152 | 0.27 | 120 | ALCH | 1 | 17.8 | 4.0 |
| Example 23 | 152 | 0.27 | 120 | ALCH | 1 | 1.5 | 4.1 |
| Example 24 | 152 | 0.27 | 120 | ALCH | 1 | 1.5 | 4.1 |
| Example 25 | 152 | 0.27 | 120 | ALCH | 1 | 1.5 | 4.1 |
| Example 26 | 152 | 0.27 | 120 | ALCH | 1 | 1.4 | 4.1 |
| Example 27 | 152 | 0.27 | 120 | ALCH | 1 | 19.2 | 4.0 |
| Example 28 | 152 | 0.27 | 120 | ALCH | 1 | 35.3 | 4.1 |
| Example 29 | 152 | 0.27 | 120 | ALCH | 1 | 36.8 | 4.1 |
| Example 30 | 152 | 0.27 | 120 | ALCH | 1 | 52.4 | 3.9 |
| Comparative | 79 | 0.29 | 120 | ALCH | 1 | 15.0 | 22.9 |
| Example 1 | | | | | | | |
| Comparative | 816 | 0.25 | 120 | ALCH | 1 | 7.7 | 1.2 |
| Example 2 | | | | | | | |
| Comparative | 152 | 0.27 | 120 | — | | | 4.0 |
| Example 3 | | | | | | | |
| Comparative | 152 | 0.27 | 120 | ALCH | 1 | 1.4 | 4.0 |
| Example 4 | | | | | | | |
| Comparative | 152 | 0.27 | 120 | ALCH | 1 | 54.3 | 3.9 |
| Example 5 | | | | | | | |

### Evaluation on Examples 1 to 30 and Comparative Examples 1 to 5

Properties of Silica Composite Particles

For the hydrophobic silica composite particles obtained from each Example and Comparative Example, the aluminum coverage, the average particle size, the particle size distribution index, and the average circularity are calculated according to the methods described previously. The results are shown in Table 2.

For the hydrophobic silica composite particles, a content of aluminum is quantified by the NET strength of constitutional elements in the particles, using an X-ray fluorescence spectrometer (XRF 1500, manufactured by Shimadzu Corporation), and then mapping is performed with an SEM-EDX (S-3400N, manufactured by Hitachi Ltd.). As a result of the investigation, it is confirmed that aluminum is present in the surface layer of the silica composite particles.

Dispersibility into Target to be Attached

In a case where the hydrophobic silica composite particles obtained from each Example and Comparative Example are dispersed in resin particles, the dispersibility of the hydrophobic silica composite particles into the resin particles is evaluated.

Specifically, hydrophobic silica composite particles are kept under an environment of a temperature of 25° C. and a humidity of 55% RH for 17 hours, and then 0.2 g of hydrophobic silica composite particles are added to 25 g of polystyrene resin particles having a particle size of 100 μm (manufactured by Soken Chemical & Engineering Co., Ltd, weight average molecular weight: 80,000) and the same is mixed by shaking with a shaking apparatus for 5 minutes, and then the surface of the resin particles is observed with an SEM and evaluated according to the following evaluation criteria. A, B and C cause no practical problem in use. The results are shown in Table 2.

Evaluation Criteria

A: Aggregates of silica composite particles are not observed, and the surface of resin particles is evenly covered by silica composite particles.

B: Aggregates of silica composite particles are not observed, but the surface of resin particles is unevenly covered by silica composite particles.

C: A slight degree of aggregates of silica composite particles are observed, and the surface of resin particles is unevenly covered by silica composite particles.

D: Aggregates of silica composite particles are scattered and the surface of resin particles is clearly unevenly covered by silica composite particles.

Fluidity of Target to be Attached

The fluidity of the resin particles (particles obtained by covering the surface of polystyrene resin particles with silica composite particles), in which the dispersibility into a target to be attached has been evaluated, is evaluated.

Specifically, 10 g of the resin particles are placed on a 75 μm sieve and vibrated at a vibration width of 1 mm for 90 seconds, and the amount of the resin particles remaining on the sieve (residue) is evaluated according to the following evaluation criteria. An amount of residue is calculated by measuring the weight of the sieve and the weight of the sieve including the residue and subtracting the former from the latter. A, B and C cause no practical problem in use. The results are shown in Table 2.

Evaluation Criteria

A: An amount of residue on the sieve is 10% by weight or less.

B: An amount of residue on the sieve is greater than 10% by weight and 15% by weight or less.

C: An amount of residue on the sieve is greater than 15% by weight and 20% by weight or less.

D: An amount of residue on the sieve is greater than 20% by weight.

TABLE 2

| | Properties of hydrophobic silica composite particles | | | | | |
|---|---|---|---|---|---|---|
| | Al coverage | Average particle | Particle size | Average | Evaluation | |
| | [atomic %] | size [nm] | distribution index | circularity | Dispersibility | Fluidity |
| Example 1 | 4.2 | 160 | 1.31 | 0.738 | A | A |
| Example 2 | 4.2 | 104 | 1.30 | 0.821 | A | B |
| Example 3 | 4.2 | 240 | 1.31 | 0.575 | A | B |
| Example 4 | 4.2 | 95 | 1.30 | 0.832 | B | B |
| Example 5 | 4.2 | 63 | 1.30 | 0.869 | B | C |
| Example 6 | 4.2 | 265 | 1.33 | 0.509 | B | C |
| Example 7 | 4.2 | 340 | 1.34 | 0.458 | B | C |
| Example 8 | 4.2 | 56 | 1.30 | 0.876 | C | C |
| Example 9 | 4.2 | 32 | 1.29 | 0.899 | C | C |
| Example 10 | 4.2 | 355 | 1.34 | 0.396 | C | C |
| Example 11 | 4.2 | 490 | 1.35 | 0.758 | C | B |
| Example 12 | 4.2 | 200 | 1.19 | 0.664 | C | B |
| Example 13 | 4.2 | 150 | 1.22 | 0.755 | B | B |
| Example 14 | 4.2 | 180 | 1.27 | 0.703 | A | A |
| Example 15 | 4.2 | 120 | 1.39 | 0.799 | B | B |
| Example 16 | 4.2 | 105 | 1.43 | 0.820 | C | B |
| Example 17 | 4.2 | 150 | 1.47 | 0.755 | C | C |
| Example 18 | 4.2 | 160 | 1.31 | 0.736 | A | B |
| Example 19 | 4.2 | 161 | 1.31 | 0.739 | A | B |
| Example 20 | 4.2 | 160 | 1.33 | 0.731 | B | C |
| Example 21 | 0.11 | 162 | 1.31 | 0.733 | A | A |
| Example 22 | 9.5 | 160 | 1.31 | 0.735 | A | A |
| Example 23 | 0.08 | 158 | 1.31 | 0.734 | B | B |
| Example 24 | 0.052 | 155 | 1.30 | 0.731 | B | B |
| Example 25 | 0.047 | 155 | 1.31 | 0.739 | C | C |
| Example 26 | 0.012 | 156 | 1.32 | 0.733 | C | C |
| Example 27 | 10.3 | 161 | 1.33 | 0.702 | A | B |
| Example 28 | 19.6 | 158 | 1.44 | 0.522 | A | B |
| Example 29 | 20.4 | 157 | 1.46 | 0.497 | C | C |
| Example 30 | 29.2 | 165 | 1.48 | 0.422 | C | C |
| Comparative Example 1 | 4.2 | 28 | 1.29 | 0.903 | D | B |
| Comparative Example 2 | 4.2 | 520 | 1.36 | 0.594 | B | D |
| Comparative Example 3 | Undetectable | 160 | 1.31 | 0.735 | D | D |
| Comparative Example 4 | 0.008 | 162 | 1.30 | 0.735 | D | D |
| Comparative Example 5 | 30.6 | 163 | 1.31 | 0.388 | D | D |

From the above results, it is seen that hydrophobic silica composite particles obtained from Examples 1 to 30 are more excellent in dispersibility into a target to be attached (polystyrene resin particles) than hydrophobic silica composite particles obtained from Comparative Examples 1 to 5, and thus, fluidity of a target to be attached (polystyrene resin particles) is less likely to be disturbed.

### Examples 31 to 60

Silica composite particles are prepared in the same manner as in Examples 1 to 30 except that hydrophobization treatment is not carried out.

### Evaluation on Examples 31 to 60

### Properties of Silica Composite Particles

For the silica composite particles obtained from Examples 31 to 60, the aluminum coverage, the average particle size, the particle size distribution index, and the average circularity are calculated according to the methods described previously. The results are shown in Table 3.

Dispersibility into Target to be Attached and Fluidity of Target to be Attached

Dispersibility into a target to be attached and fluidity of a target to be attached are evaluated in the same method described above. The results are shown in Table 3.

TABLE 3

| | Production | Properties of silica composite particles | | | | | |
|---|---|---|---|---|---|---|---|
| | condition except | | Average | Particle size | | | |
| | hydrophobization | Al coverage | particle | distribution | Average | Evaluation | |
| | treatment step | [atomic %] | size [nm] | index | circularity | Dispersibility | Fluidity |
| Example 31 | Example 1 | 4.9 | 160 | 1.31 | 0.738 | B | B |
| Example 32 | Example 2 | 4.9 | 104 | 1.30 | 0.821 | B | B |
| Example 33 | Example 3 | 4.9 | 240 | 1.31 | 0.575 | B | B |
| Example 34 | Example 4 | 4.8 | 95 | 1.30 | 0.832 | B | B |
| Example 35 | Example 5 | 4.9 | 63 | 1.30 | 0.869 | B | C |
| Example 36 | Example 6 | 4.8 | 265 | 1.33 | 0.509 | B | C |
| Example 37 | Example 7 | 4.9 | 340 | 1.34 | 0.458 | B | C |
| Example 38 | Example 8 | 4.8 | 56 | 1.30 | 0.876 | C | C |
| Example 39 | Example 9 | 4.9 | 32 | 1.29 | 0.899 | C | C |
| Example 40 | Example 10 | 4.8 | 355 | 1.34 | 0.396 | C | C |
| Example 41 | Example 11 | 4.9 | 490 | 1.35 | 0.758 | C | B |
| Example 42 | Example 12 | 4.9 | 200 | 1.19 | 0.664 | C | B |
| Example 43 | Example 13 | 4.9 | 150 | 1.22 | 0.755 | B | B |
| Example 44 | Example 14 | 4.9 | 180 | 1.27 | 0.703 | B | B |
| Example 45 | Example 15 | 4.8 | 120 | 1.39 | 0.799 | B | B |
| Example 46 | Example 16 | 4.9 | 105 | 1.43 | 0.820 | C | B |
| Example 47 | Example 17 | 4.9 | 150 | 1.47 | 0.755 | C | C |
| Example 48 | Example 18 | 4.9 | 160 | 1.31 | 0.736 | B | B |
| Example 49 | Example 19 | 4.9 | 161 | 1.31 | 0.739 | B | B |
| Example 50 | Example 20 | 4.9 | 160 | 1.33 | 0.731 | B | C |
| Example 51 | Example 21 | 0.21 | 162 | 1.31 | 0.733 | B | B |
| Example 52 | Example 22 | 10.2 | 160 | 1.31 | 0.735 | B | B |
| Example 53 | Example 23 | 0.15 | 158 | 1.31 | 0.734 | B | C |
| Example 54 | Example 24 | 0.10 | 155 | 1.30 | 0.731 | B | C |
| Example 55 | Example 25 | 0.09 | 155 | 1.31 | 0.739 | C | C |
| Example 56 | Example 26 | 0.024 | 156 | 1.32 | 0.733 | C | C |
| Example 57 | Example 27 | 11.0 | 161 | 1.33 | 0.702 | B | B |
| Example 58 | Example 28 | 20.4 | 158 | 1.44 | 0.522 | B | B |
| Example 59 | Example 29 | 21.2 | 157 | 1.46 | 0.497 | C | C |
| Example 60 | Example 30 | 29.8 | 165 | 1.48 | 0.422 | C | C |

As seen from the comparison of Table 2 and Table 3, some of Examples 1 to 30 are particularly excellent in dispersibility and fluidity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. Silica composite particles in which silica particles are subjected to surface treatment with an aluminum compound in which an organic group is bonded to an aluminum atom through an oxygen atom, and an aluminum surface coverage is from 0.01 atomic % to 30 atomic %, an average particle size is from 30 nm to 500 nm, and a particle size distribution index is from 1.1 to 1.5.

2. The silica composite particles according to claim 1,
wherein an average circularity is from 0.5 to 0.85.

3. The silica composite particles according to claim 1,
wherein the aluminum compound has one or more alkoxy groups.

4. Silica composite particles in which silica particles are subjected to surface treatment sequentially with an aluminum compound in which an organic group is bonded to an aluminum atom through an oxygen atom and a hydrophobizing agent, and an aluminum surface coverage is from 0.01 atomic % to 30 atomic %, an average particle size is from 30 nm to 500 nm, and a particle size distribution index is from 1.1 to 1.5.

5. The silica composite particles according to claim 4,
wherein an average circularity is from 0.5 to 0.85.

6. The silica composite particles according to claim 4,
wherein the aluminum compound has one or more alkoxy groups.

7. The silica composite particles according to claim 4,
wherein the hydrophobizing agent is an organic silicon compound.

8. The silica composite particles according to claim 7,
wherein the organic silicon compound has a trimethyl group.

9. The silica composite particles according to claim 4,
wherein the hydrophobizing agent is trimethylmethoxysilane or hexamethyldisilazane.

10. The silica composite particles according to claim 4,
wherein an amount of the hydrophobizing agent used is from 1% by weight to 60% by weight with respect to the silica composite particles.

11. A method of producing silica composite particles comprising:
preparing an alkali catalyst solution containing an alkali catalyst in a solvent containing alcohol;
supplying tetraalkoxysilane and an alkali catalyst to the alkali catalyst solution to form silica particles; and
supplying a mixed solution of an aluminum compound in which an organic group is bonded to an aluminum atom through an oxygen atom and alcohol, with a concentration of the aluminum compound of from 0.05% by weight to 10% by weight, to the alkali catalyst solution in which the silica particles are formed, to subject the silica particles to surface treatment with the aluminum compound.

12. The method of producing silica composite particles according to claim 11, further comprising:
subjecting the silica particles, which have been subjected to surface treatment with the aluminum compound, to surface treatment with a hydrophobizing agent.

13. The method of producing silica composite particles according to claim 12,
wherein the subjecting of the silica particles to surface treatment with a hydrophobizing agent is carried out in supercritical carbon dioxide.
